(19) United States
(12) Patent Application Publication
(10) Pub. No.: US 2010/0207835 A1
(43) Pub. Date: Aug. 19, 2010

(54) SLOT ANTENNA

(76) Inventor: Toru Taura, Tokyo (JP)

Correspondence Address: Mr. Jackson Chen, 6535 N. STATE HWY 161, IRVING, TX, 75039, US

(21) Appl. No.: 12/600,222

(22) PCT Filed: Apr. 17, 2008
(86) PCT No.: PCT/JP2008/057495

§ 371 Date: Nov. 13, 2009

(30) Foreign Application Priority Data
May 16, 2007 (JP) 2007-130850

(51) Int. Cl. H01Q 13/10

(52) U.S. Cl. 343/770; 343/767

(57) ABSTRACT

To make an antenna wideband under thin state. The slot antenna includes an antenna element having an aperture type slot, a reflector disposed by opposing to the antenna element, a feeding device which is electrically and physically connected to the antenna element and the reflector, a short-circuiting device which electrically short-circuits the antenna element and the reflector, and a reducing device which reduces the reactance component of the antenna. Since the reducing device for reducing the reactance component of the antenna is provided, the reactance component of the antenna can be reduced even if the antenna is formed thin and the antenna can be made wideband regardless of its thinness.

### TECHNICAL FIELD

The present invention relates to a slot antenna having a reflector. More specifically, the present invention relates to a thin-type slot antenna having a wideband characteristic.

### BACKGROUND ART

Recently, portable wireless terminals have been required to be thin and to have a connecting function to various wireless networks. Accordingly, there has been an increasing demand for the antenna loaded on the portable wireless terminal to be thin because of limited mounting space and demand for corresponding to multibands required for being connected to various kinds of wireless services.

As the terminals become thinner, the antennas loaded on the portable wireless terminals become susceptible to the external factors such as hands or human bodies because the distance between the antenna and the external factors becomes close when the terminals are in use. This results in causing deterioration in the communication performance of the terminals, particularly the deterioration of the antenna characteristic during communications, due to deterioration in the antenna characteristic.

As a structure for lightening the influence, there is known a structure in which a metal plate (reflector) is interposed between the antenna and the external loss factor. In the antenna structure having the reflector, an operation band generally becomes narrower when the distance between the reflector and the antenna becomes closer. Thus, as a technique for widening the band of the antenna structure having the reflector, there is disclosed a structure in which a plurality of antenna elements are stacked (Patent Documents 1 and 2, for example).

As shown in FIGS. 6A and 6B, in an antenna device disclosed in Patent Document 1, a microstrip antenna having a radiation element 30 is formed on a dielectric substrate 32, a parasitic element 31 is loaded on the microstrip antenna, and it is a band widening technique which utilizes double resonance by the microstrip antenna, particularly the radiation element 30 and the parasitic element 31.

As shown in FIG. 7, a 2-frequency common-use microstrip antenna disclosed in Patent Document 2 is an antenna structure in which two microstrip antennas 40, 41 are stacked vertically, and it is a technique which widens the band by achieving a 2-frequency common characteristic through feeding power to each of the two microstrip antennas 40, 41 of different resonance frequencies.

### Patent Document 1: Japanese Unexamined Patent Publication 2001-326528

### Patent Document 2: Japanese Unexamined Patent Publication 2003-249818

### DISCLOSURE OF THE INVENTION

### Problems to be Solved by the Invention

However, the antenna structures disclosed in Patent Document 1 and Patent Document 2 are the structures in which the antenna elements are stacked vertically for achieving the double-resonance characteristic, so that the thickness of the antenna becomes thick.

An object of the present invention relates to the slot antenna having a reflector, and it is to provide the slot antenna which can be formed thin and can achieve the wideband characteristic.

### Means for Solving the Problem

In order to achieve the foregoing object, the slot antenna according to the present invention includes: an antenna element having an aperture type slot; a reflector disposed by being opposed to the antenna element; a feeding device which is electrically and physically connected to the antenna element and the reflector; a short-circuiting device which electrically short-circuits the antenna element and the reflector; and a reducing device which reduces a reactance component of the antenna.

### EFFECT OF THE INVENTION

The present invention is capable of providing the slot antenna which can be formed thin and can achieve the wideband characteristic.

### BEST MODES FOR CARRYING OUT THE INVENTION

Hereinafter, an exemplary embodiment of the invention will be described in detail by referring to the drawings.

As shown in FIG. 1 and FIG. 2, a slot antenna according to the exemplary embodiment of the invention includes, as a basic structure: an antenna element 2 having an aperture type slot 1; a reflector 3 disposed by opposing to the antenna element 2; a feeding device 4 which is electrically and physically connected to the antenna element 2 and the reflector 3; a short-circuiting device 5 which electrically short-circuits the antenna element 2 and the reflector 3; and a reducing device which reduces the reactance component of the antenna.

In a case of a transmitting antenna, the feeding device 4 functions as a power feeding terminal which feeds power to the antenna element and the reflector for sending transmission signals. In a case of a receiving antenna, the feeding device 4 functions as a power receiving terminal which takes in electric currents that are induced on the antenna by the incoming electromagnetic waves.

The slot antenna is formed by making a thin and long cut into a metal plate. As the slots formed by the cutting, there are a structure where both ends are closed and a structure whose one end is open (notch shape). The slot antenna according to the exemplary embodiment of the invention is directed to the latter structure, i.e., the structure whose one end is open.

Considering a case where the exemplary embodiment of the invention functions as a transmitting antenna, when an electric field and a magnetic field are generated in the slot 1 through feeding the power by the feeding device 4 located in the periphery of a short-circuit end 1b of the slot 1, there is generated the resonance with which the electric field becomes the maximum at an opening end 1a of the slot 1 and becomes the minimum at the short-circuit end 1b when the slot length becomes one fourth of the used frequency wavelength. This enables the slot antenna to function as the antenna.

Particularly, the reactance component of the antenna becomes increased as the antenna is formed thinner. Thus, the band of the antenna is narrowed. The exemplary embodiment of the invention has the reducing device for reducing the reactance component of the antenna. Therefore, with the exemplary embodiment of the invention, wideband of the antenna can be achieved even though it is a thin-type antenna, since it is a structure which can reduce the reactance component of the antenna even though the antenna is formed thin.

Hereinafter, the slot antenna according to the exemplary embodiment of the invention will be described in detail by referring to specific examples.

### Example 1

As shown in FIG. 1A, FIG. 1B, and FIG. 1C, the slot antenna according to EXAMPLE 1 of the present invention includes an antenna element 2 having an aperture type slot 1, a reflector 3, a feeding device 4, a short-circuiting device 5, and a reducing device.

As shown in FIG. 1A and FIG. 1B, the antenna element 2 has an emission plate 2a and the slot 1. The radiation plate 2a is formed from a vertically oriented metal flat plate. The slot 1 is formed by making a thin and long cut on the radiation plate 2a. One end (opening end) 1a of the long side of the slot 1 is opened towards the outer side from an end 2b of the radiation plate 2a, and the other end (closed end) 1b of the long side of the slot 1 is closed while being located at a position on the inner side with respect to the end 2b of the radiation plate 2a.

In EXAMPLE 1 shown in FIG. 1A and FIG. 1B, another slot 6 is provided in addition to the slot 1. Like the slot 1, the slot 6 is formed by making a long and thin cut on the radiation plate 2a. One end (opening end) 6a of the long side of the slot 6 is opened towards the outer side from the end 2b of the radiation plate 2a, and the other end (closed end) 6b of the long side of the slot 6 is closed while being located on the inner side with respect to the end 2b of the radiation plate 2a.

In FIG. 1A and FIG. 1B, the slots 1 and 6 of the antenna element 2 are formed in an L-letter shape, and the lengths thereof are set to an electric length of a quarter wavelength of the frequency to be used.

As shown in FIG. 1A and FIG. 1B, the reflector 3 is formed as a vertically oriented metal flat plate whose size is larger than that of the antenna element 2. The reflector 3 is disposed to oppose to the antenna element 2 so as to reflect electromagnetic waves. The end 3a of the reflector 3 and the end 2b of the antenna element 2 where the opening ends 1a, 6a of the slots 1, 6 are provided are arranged to be on the same surface.

As shown in FIG. 1B and FIG. 1C, the feeding device 4 is connected to the antenna element 2 and the reflector 3 electrically and physically. To electrically and physically connect means that the feeding device 4 is mechanically connected to the antenna element 2 and the reflector 3 and, while keeping that coupled state, the feeding device 4 is electrically conductive to the antenna element 2 and the reflector 3.

As shown in FIG. 1B, the feeding device 4 is physically and electrically connected to the antenna element 2 and the reflector 3 in a narrow-width area A of the slots 1, 6 in the vicinity of the closed ends 1a, 6a of the slots 1, 6.

As shown in FIG. 1B and FIG. 1C, the short-circuit device 5 electrically short-circuits the antenna element 2 and the reflector 3.

In EXAMPLE 1 shown in FIG. 1B and FIG. 1C, the short-circuiting device 5 is disposed between the antenna element 2 and the reflector 3, and it is placed in the vicinity of the feeding device 4 so as to electrically short-circuit the antenna element 2 and the reflector 3.

Further, the reducing device of EXAMPLE 1 shown in FIG. 1 reduces the reactance component of the antenna, and it is directly provided to the slot 1. In EXAMPLE 1 shown in FIG. 1A and FIG. 1B, the opening area of the slot 1 is expanded in the vicinity of the feeding device 4. Specifically, an inner side 1c of the right-angle corner of the slot 1 formed in an L-letter shape is cut obliquely (reducing device) to reduce the reactance component.

In a case of a transmitting antenna, the feeding device 4 used for the slot antenna functions as a power feeding terminal which feeds power to the antenna element and the reflector for sending transmission signals. In a case of a receiving antenna, the feeding device 4 functions as a power receiving terminal which takes in electric currents that are induced on the antenna by the incoming electromagnetic waves.

In general, the slot antenna is formed by making a thin and long cut into a metal plate. In addition to the thin and long cut shape as the shapes of the slot, there is also a notch shape whose one end is an open end. EXAMPLE 1 of the present invention is directed to the slot antenna having the latter shape, i.e., the notch shape.

In the embodiment of EXAMPLE 1 shown in FIG. 1, considering a case where the slot antenna functions as a transmitting antenna, when an electric field and a magnetic field are generated in the slots 1, 6 through feeding the power by the feeding device 4 located in the periphery of the short-circuit end 1b of the slot 6 between the slots 1 and 6, there is generated the resonance with which the electric field becomes the maximum at the opening ends 1a, 6a of the slots 1, 6 and becomes the minimum at the short-circuit ends 1b, 6b when the slot length becomes one fourth of the used frequency wavelength. This enables the slot antenna to function as the antenna.

With the antenna structure of EXAMPLE 1 shown in FIG. 1, resonance is generated at frequencies depending on the respective slot electric lengths of the slots 1 and 6. In addition, resonance is generated in the L-letter shaped conductor (radiation plate 2a) formed neighboring to (upper section) the slot 6 at a frequency depending of the length and the width thereof because the slot 6 is provided. Therefore, the resonance is generated at above-described three frequencies with the antenna structure according to EXAMPLE 1 of the present invention shown in FIG. 1.

Next, operations of the slot antenna according to EXAMPLE 1 of the present invention as the transmitting antenna will be described.

When the power of the frequency having the electric length of the slots 1, 6 as a quarter wavelength is fed to the antenna element 2 and the reflector 3 from the feeding device 4, resonance is induced in the slots 1, 6. Thereby, electromagnetic waves are emitted by the electric fields distributed on the slots 1, 6 and the electric currents spread on the antenna element 2 and the reflector 3 from the slots 1, 6. At this time, the emission direction of the electromagnetic waves exhibits a directivity by the effect of the reflector 3, and stronger emission is generated on the side where the slots are disposed.

Next, operations of the slot antenna according to EXAMPLE 1 of the present invention as the receiving antenna will be described.

When the electromagnetic waves of the frequency having the electric length of the slots 1, 6 as a quarter wavelength come in, electric currents are induced in the antenna element 2, and an electric field and a magnetic field are induced on the slots 1, 6, respectively, which are received via the feeding device 4. At this time, because the reflector 3 is employed, the slot antenna exhibits a still higher sensitivity for the electromagnetic waves coming in from the side where the slots 1, 6 are disposed.

With the related antenna structure having the reflector, the impedance of the antenna is deteriorated when the distance between the antenna element and the reflector is shortened for thinning the antenna. This causes mismatching with a wireless circuit, so that it becomes difficult to perform transmission/reception with high efficiency. The wireless circuit is a circuit which is electrically connected to the feeding device 4, and it is not illustrated in FIG. 1.

In EXAMPLE 1 shown in FIG. 1, the short-circuiting device 5 is disposed in the vicinity of the feeding device 4, i.e., in the vicinity on the closed ends 1b, 6b sides of the slots 1, 6 so as to prevent deterioration of the impedance of the antenna. This makes it possible to improve matching with the wireless circuit, so that transmission/reception can be done efficiently.

With the antenna structure of EXAMPLE 1 shown in FIG. 1, particularly the slot 1 is formed in a shape in which the inner side 1c of the L-letter shaped right-angle corner is cut obliquely, and the opening area (a part from which the conductor is eliminated) in the vicinity of the feeding device 4 is secured wide. Therefore, the reactance component in the periphery of the feeding device 4 can be reduced, so that the band of the antenna can be widened.

Particularly, the reactance component is radically increased as the antenna becomes thinner. Thus, the structure of EXAMPLE of the present invention in which the slot opening area in the periphery of the feeding device 4 is secured wide can largely contribute to widen the band of the antenna.

Regarding the slot 1, the slot shape in which the L-letter shaped corner is cut obliquely comes to have a short slot length, and the resonance frequency becomes high. In order to obtain the resonance at a low frequency, the L-letter shape may be formed longer. However, the area occupied by the slot becomes larger in that case. In order to avoid it, it is possible to employ a structure in which a part of the L-letter shaped slot is formed in a meander shape or a spiral shape to suppress the occupied area, and also the slot length is formed long.

Next, specific examples of the feeding device 4 will be described by referring to FIG. 3-FIG. 4.

The feeding device 4 shown in FIG. 3 has a resin block 4a and a spring pin 4b. The reflector 3 shown in FIG. 3 is configured with a printed circuit board 3c having a plurality of solid GND layers 3b. As shown in FIG. 3, the resin block 4a of the feeding device 4 is attached on the reflector 3, and the spring pin 4b of the feeding device 4 is electrically insulated from the reflector 3 at the resin block 4a, and electrically connected to the radiation plate 2a of the antenna element 2.

In a case of the transmitting antenna, a power feeding route from the wireless circuit, not shown, is structured to feed the power to the antenna by being electrically connected to the spring pin 4b and the solid GND layers 3b of the reflector 3. Further, in a case of the receiving antenna which functions as the receiving antenna in which the electric current is flown to the antenna element 2 and the electric field and magnetic field are induced on the slots 1, 6, reception signals are transmitted to the wireless circuit, not shown, via the power feeding route, not shown, which is connected to the spring pin 4b and the solid GND layers 3b of the reflector 3.

The feeding device 4 shown in FIG. 3 is in a structure in which the spring pin 4b is insulated by using the resin block 4a. Through eliminating the solid GND layer 3b on the top layer of the printed circuit board right beneath the spring pin 4b (an area from which the solid GND layer 3b is eliminated is shown as 3d), the reactance component of the antenna can be reduced. Therefore, through employing the feeding device 4 shown in FIG. 3, the band of the antenna can be widened further in addition to the effect achieved by the shape of the slot 1 described above.

In EXAMPLE shown in FIG. 3, described is the case where the solid GND layer 3b on the top layer of the printed circuit board in the area right beneath the spring pin 4b is eliminated for reducing the parasitic capacitance generated between the spring pin 4b and the reflector 3 as the structure (reducing device) for reducing the reactance component of the antenna. However, the present invention is not limited only to such case.

The feeding device 4 shown in FIG. 4 is an example in which the spring pin 4b shown in FIG. 3 is modified to a plate spring 4c. In EXAMPLE shown in FIG. 4, as a structure (reducing device) for reducing the reactance component of the antenna when feeding the power and receiving waves, the solid GND layer 3b on the top layer of the printed circuit board in the area right beneath the spring pin 4b is eliminated for reducing the parasitic capacitance generated between the plate spring 4c and the reflector 3. Other structures are the same as those shown in FIG. 3.

As the structure (reducing device) for reducing the reactance component of the antenna, the feeding device 4 shown in FIG. 5 is formed as a structure in which the solid GND layer 3b formed on the top layer of the printed circuit board 3c which configures the reflector 3 shown in FIG. 3 is eliminated, and the solid GND layer 3b is formed only on the back face layer of the printed circuit board 3c in order to reduce the parasitic capacitance between the feeding device 4 and the reflector 3. Other structures are the same as those shown in FIG. 3.

The feeding devices 4 shown in FIG. 4 and FIG. 5 can provide the same effects as those of the feeding device 4 shown in FIG. 3. Further, the reducing devices shown in FIG. 4 and FIG. 5 can provide the same effects as those of the reducing device according to EXAMPLE shown in FIG. 3.

### Example 2

The slot antenna according to EXAMPLE 2 shown in FIG. 2A, FIG. 2B, and FIG. 2C is a modification of EXAMPLE 1 shown in FIG. 1. In EXAMPLE shown in FIG. 1, the opening area of the slot 1 in the vicinity of the feeding device 4 is expanded as the structure (reducing device) for reducing the reactance component of the antenna. However, the present invention is not limited only to such case. It is also possible to employ a reducing device shown in FIG. 2.

In EXAMPLE 2 shown in FIG. 2A, FIG. 2B, and FIG. 2C, the reactance component for the slot 1 is reduced by having the end 2b of the antenna element 2 projected towards the outer side than the end 3a of the reflector 3. Other structures are the same as those shown in FIG. 1 and FIG. 3-FIG. 5.

In EXAMPLE 2 shown in FIG. 2A, FIG. 2B, and FIG. 2C, the end 2b of the antenna element 2 is disposed by being shifted on the outer side with respect to the end 3a of the reflector 3. Therefore, the reactance component for the slot 1 can be decreased and the antenna band can be expanded. Particularly, the effects thereof become conspicuous by shifting the end 2b of the antenna element 2 where the opening end 1a of the slot 1 in which the strong electric field components are concentrated is provided with respect to the reflector 3.

Further, through shifting the end 2b of the antenna element 2 at the opening end 1a of the slot 1, it is possible to keep the side edge part of the antenna element 2 away from the side edge part of the reflector 3. This makes it possible to suppress induction of the induced electric currents which hinder emission and reception, without increasing the thickness of the antenna. Thereby, it becomes possible to achieve an antenna which can be formed thin and can emit and receive electromagnetic waves efficiently.

In FIG. 2, the end 2b of the antenna element 2 is shifted towards the outer side with respect to the reflector 3. However, the present invention is not limited only to such case. For example, as the structure for reducing the reactance component for the slot 1, it is possible to employ a structure in which a part of the reflector 3 right beneath the slot 1 is eliminated. Particularly, the effects thereof become conspicuous when the reflector 3 right beneath the opening end 1a of the slot 1 where the electric field components are concentrated is eliminated.

While the reducing devices shown in FIG. 2 and FIGS. 3-5 have been described as the reducing devices for reducing the reactance component of the antenna, the present invention is not limited only to such cases. Any kinds of devices other than those shown in FIG. 2 and FIGS. 3-5 may be used as the reducing devices for reducing the reactance component of the antenna, as long as the devices can reduce the parasitic capacitance between the reflector and the feeding device or can reduce the parasitic capacitance between the antenna element and the feeding device.

In the explanations above, the shape of the slots 1 and 6 provided on the antenna element 2 is described as an L-letter shape. However, the present invention is not limited only to that shape. The shape of the slots 1 and 6 is not necessarily limited to the L-letter shape, and other shapes may be employed as long as the opening area of the slots 1 and 6 in the periphery of the feeding device 4 can be secured wide. For example, the band of the antenna can be widened by employing the shape where the opening area in the vicinity of the feeding device is widened while having the shape such as a straight type, a meander type, a U-letter shape, or a Bow-Tie type used as the base.

Further, it is possible to have resonance, antenna actions, and sensitivities for polarized waves in the horizontal or perpendicular direction at low frequencies while reducing the area occupied by the slot.

Furthermore, while the number of slots has been described by referring to the case where there are two slots, it is possible to employ a structure having a multiple resonance characteristic by providing more slots. Moreover, there has been described above assuming that there is one feeding device. However, a plurality of feeding devices may be loaded as well. For example, when there are two or more slots disposed, the feeding device may be provided to each of the slots.

Further, while there has been described by referring to the case where the structure for reducing the reactance component is employed only to the slot 1, the present invention is not limited only to such case. It is also possible to select and employ the structure for reducing the reactance component for all the slots 1, 6 provided to the antenna element 2 or a part of the slots as appropriate.

While the present invention has been described by referring to the embodiments (and examples), the present invention is not limited only to those embodiments (and examples) described above. Various kinds of modifications that occur to those skilled in the art can be applied to the structures and details of the present invention within the scope of the present invention.

This Application claims the Priority right based on Japanese Patent Application No. 2007-130850 filed on May 16, 2007, and the disclosure thereof is hereby incorporated by reference in its entirety.

### INDUSTRIAL APPLICABILITY

As described above, the present invention is capable of reducing the reactance component at the power feeding point under a state where the antenna is formed thin, so that thinning the antenna and widening the band can be achieved at the same time.

### BRIEF DESCRIPTION OF THE DRAWINGS

FIG. 1A is a perspective view showing a slot antenna according to EXAMPLE 1 of the present invention, FIG. 1B is a plan view showing the slot antenna according to EXAMPLE 1 of the present invention, and FIG. 1C is a sectional view showing the slot antenna according to EXAMPLE 1 of the present invention;

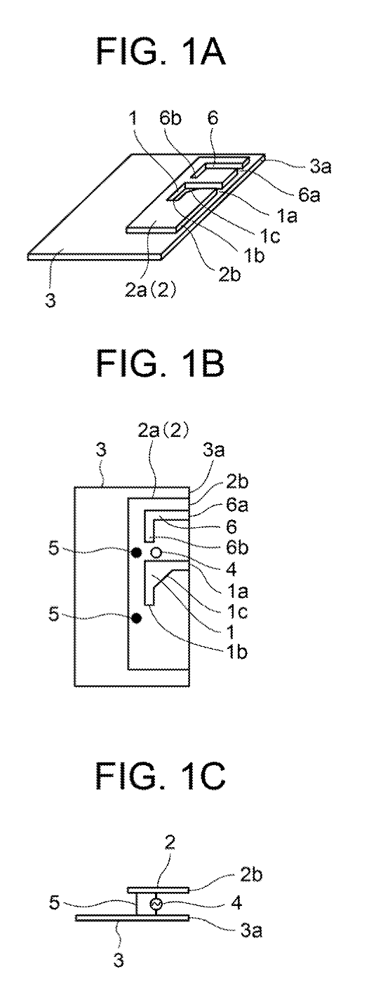

FIG. 2A is a perspective view showing a slot antenna according to EXAMPLE 2 of the present invention, FIG. 2B is a plan view showing the slot antenna according to EXAMPLE 2 of the present invention, and FIG. 2C is a sectional view showing the slot antenna according to EXAMPLE 2 of the present invention;

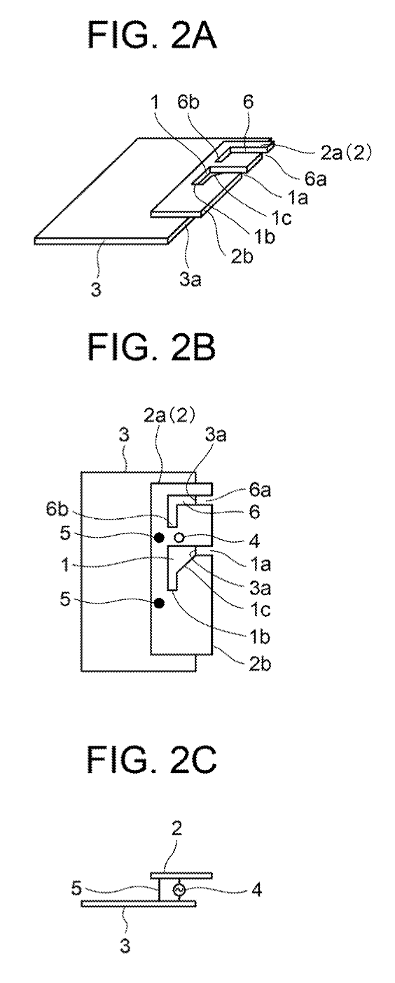

FIG. 3 is a sectional view showing a feeding device according to EXAMPLE of the present invention;

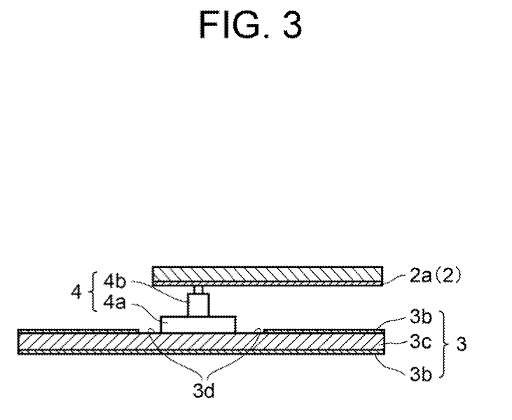

FIG. 4 is a sectional view showing a feeding device according to EXAMPLE of the present invention;

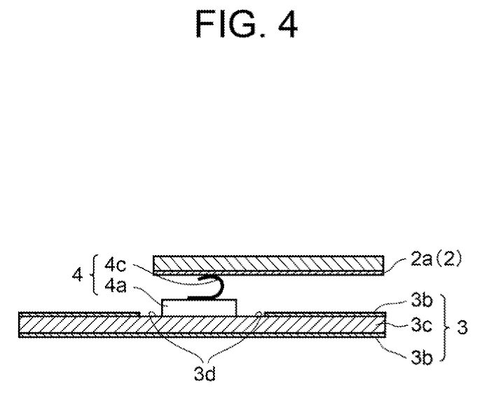

FIG. 5 is a sectional view showing a feeding device according to EXAMPLE of the present invention;

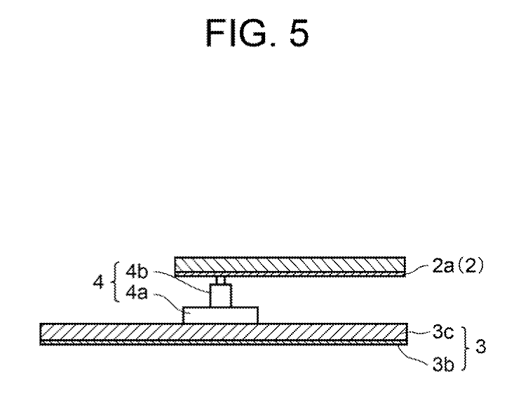

FIG. 6 A is a detailed perspective view showing an antenna according to a related technique, and FIG. 6B is a sectional view thereof; and

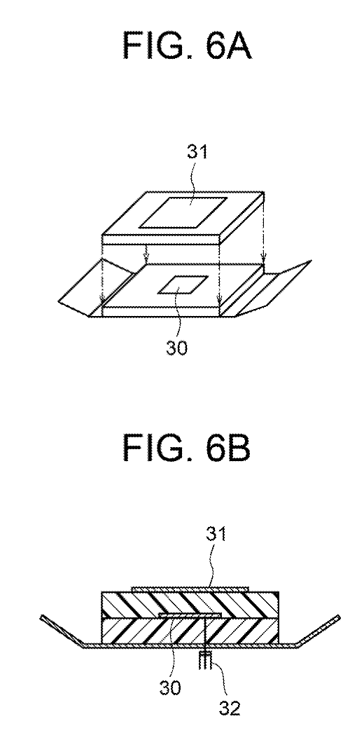

FIG. 7 is a sectional view showing an antenna according to a related technique.

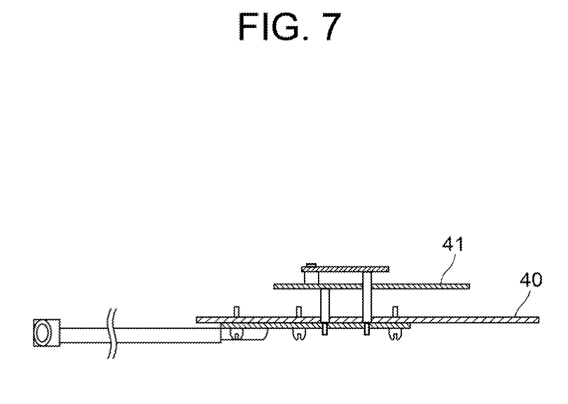

### REFERENCE NUMERALS

1 Slot
1a Opening end of slot
1b Closed end of slot
Antenna element
Reflector
Feeding device
Short-circuiting device
Slot
6a Opening end of slot
6b Closed end of slot

What is claimed is:

1. A slot antenna, comprising:
an antenna element having an aperture type slot;
a reflector disposed by being opposed to the antenna element;
a feeding device which is electrically and physically connected to the antenna element and the reflector;
a short-circuiting device which electrically short-circuits the antenna element and the reflector; and
a reducing device which reduces a reactance component of the antenna.

2. The slot antenna as claimed in claim 1, wherein the reducing device is directly provided to the slot.

3. The slot antenna as claimed in claim 2, wherein the reducing device is formed as a structure in which an opening area of the slot is expanded near the feeding device.

4. The slot antenna as claimed in claim 1, wherein the reducing device reduces a parasitic capacitance between the feeding device and the reflector.

5. The slot antenna as claimed in claim 1, wherein the reducing device is formed as a structure in which an end of the antenna element where an opening end of the slot is formed is shifted with respect to an end of the reflector.

6. The slot antenna as claimed in claim 1, wherein the short-circuiting device is placed between the antenna element and the reflector, and electrically short-circuits the antenna element and the reflector near a closed end of the slot.

7. A slot antenna, comprising:
an antenna element having an aperture type slot;
a reflector disposed by being opposed to the antenna element;
a feeding device which is electrically and physically connected to the antenna element and the reflector;
short-circuiting means for electrically short-circuiting the antenna element and the reflector; and
reducing means for reducing a reactance component of the antenna.
